(19) United States
(12) Patent Application Publication
(10) Pub. No.: US 2014/0379410 A1
(43) Pub. Date: Dec. 25, 2014

(54) PROTOCOL-AWARE SCHEDULING

(71) Applicant: KONINKLIJKE PHILIPS N.V., EINDHOVEN (NL)

(72) Inventor: Michael Chun-chieh Lee, Lexington, MA (US)

(21) Appl. No.: 14/308,842

(22) Filed: Jun. 19, 2014

Related U.S. Application Data
(60) Provisional application No. 61/837,244, filed on Jun. 20, 2013.

(51) Int. Cl. G06F 19/00; G06Q 10/06

(52) U.S. Cl. CPC G06F 19/327; G06Q 10/06314
USPC 705/7.24

(57) ABSTRACT

A method creates an electronically formatted schedule for imaging examinations. The method includes receiving a set of imaging examination orders, determining a protocol for each imaging examination order in the set of imaging examination orders, identifying an expected examination time duration of each of the protocols, and creating the electronically formatted schedule based on the expected examination time durations. A computing apparatus (102) includes an input device (110) that receives a set of imaging examination orders, an information extractor (202) that extracts information that determines a protocol of each imaging examination orders in the set, an expected examination duration identifier (206) that identifies an expected examination time duration of each of the protocols, and a schedule creator (220) that creates an electronically formatted schedule for the set of imaging examination orders based on the expected examination time durations.

The following generally relates to scheduling imaging examinations of subjects based on estimated imaging examination time duration for predicted and/or actual imaging protocols corresponding to the imaging examinations.

In radiology, orders for imaging examinations (such as magnetic resonance imaging (MRI), computed tomography (CT), x-ray, and the like) are received by the radiology department, and in response, a scheduler (human or computer) allocates a date and a general time block for the imaging examination. A few days to a few hours before the exam, a protocol is assigned to imaging examination, specifying in technical detail how the specific examination should be conducted.

By way of example, an order may arrive at the radiology department for a “MRI of the brain,” which is allocated a general time block, e.g., one hour. After protocoling, it may be determined that the “MRI of the brain” order should receive a lengthy (time-intensive) protocol such as a brain tumor protocol with diffusion imaging or a shorter protocol such as an adult brain screen.

Because the protocol (and hence the expected duration of the examination) is determined after the block of time is allocated, the actual imaging examination may be shorter or longer than the allocated block of time. Where the imaging examination is shorter than the allocated block of time, the imaging system is underutilized, with dead-time on the imaging system in which no patients are scanned. Where the imaging examination is longer than the allocated block of time, the imaging examinations scheduled after this examination may end up being delayed or cancelled.

An approach to mitigating the foregoing includes varying the blocks of time for examinations based on expected or planned examination duration. Unfortunately, the schedule is typically created before the protocol is assigned, e.g., in order for the subject and/or other imaging facility to have adequate lead time to add the imaging examination to their agendas and/or adjust other matters accordingly.

Aspects described herein address the above-referenced problems and others.

In one aspect, a method creates an electronically formatted schedule for imaging examinations. The method includes receiving a set of imaging examination orders, determining a protocol for each imaging examination order in the set of imaging examination orders, identifying an expected examination time duration of each of the protocols, and creating the electronically formatted schedule based on the expected examination time durations.

In another aspect, a computing apparatus includes an input device that receives a set of imaging examination orders, an information extractor that extracts information that identifies a protocol of each imaging examination orders in the set, an expected examination duration identifier that identifies an expected examination time duration of each of the protocols, and a schedule creator that creates an electronically formatted schedule for the set of imaging examination orders based on the expected examination time durations.

In another aspect, a computer readable storage medium encoded with computer readable instructions, which, when executed by a processer, causes the processor to: receive a set of imaging examination orders, determine a protocol of each of the imaging examination orders in the set of imaging examination orders, identify an expected examination time duration of each of the protocols, and create the electronically formatted schedule based on the expected examination time durations.

The invention may take form in various components and arrangements of components, and in various steps and arrangements of steps. The drawings are only for purposes of illustrating the preferred embodiments and are not to be construed as limiting the invention.

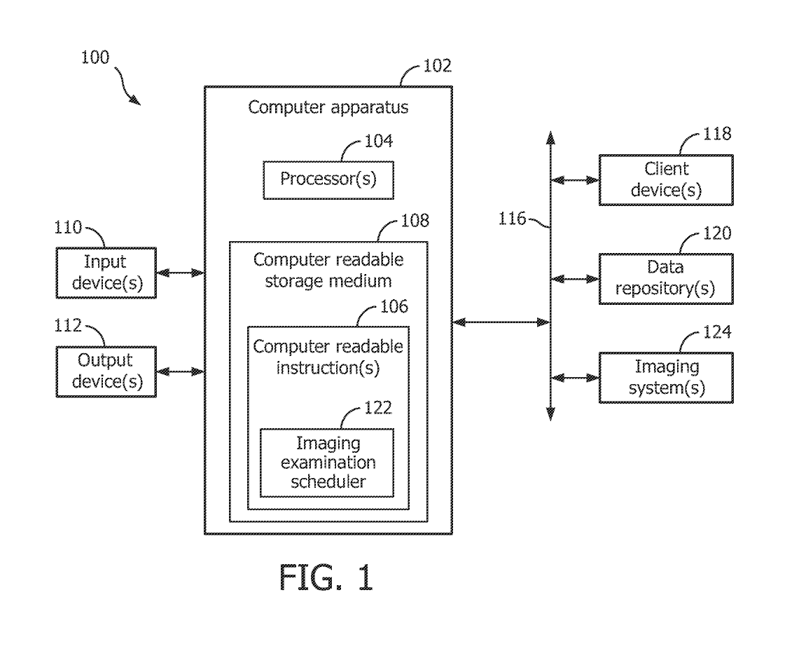

FIG. 1 schematically illustrates an example system including a computing apparatus that implements an imagining examination scheduler.

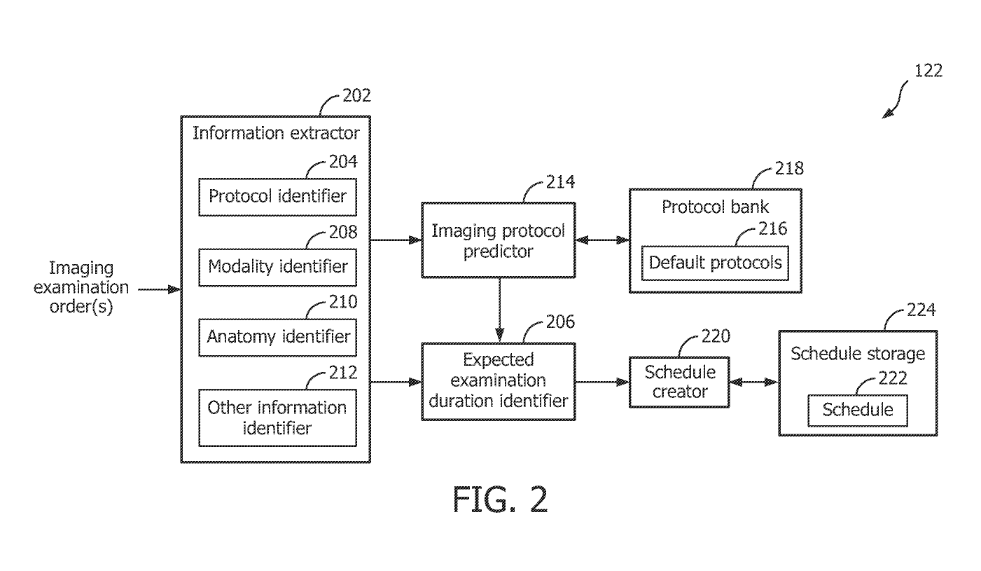

FIG. 2 schematically illustrates an example of the imagining examination scheduler.

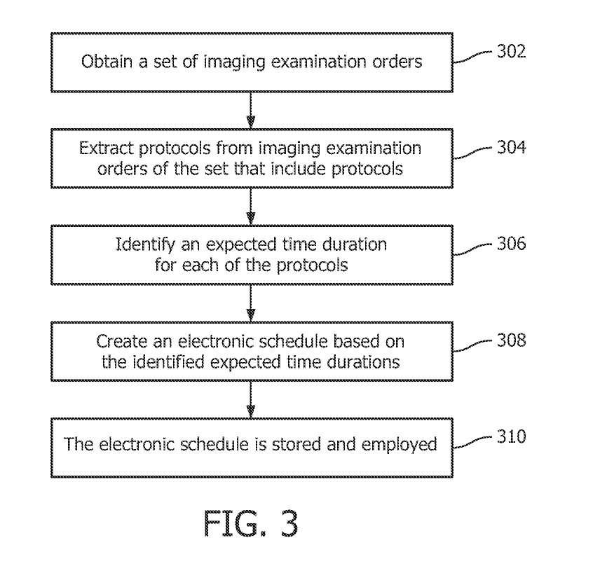

FIG. 3 illustrates an example method that facilitates generating a schedule for imaging examination orders.

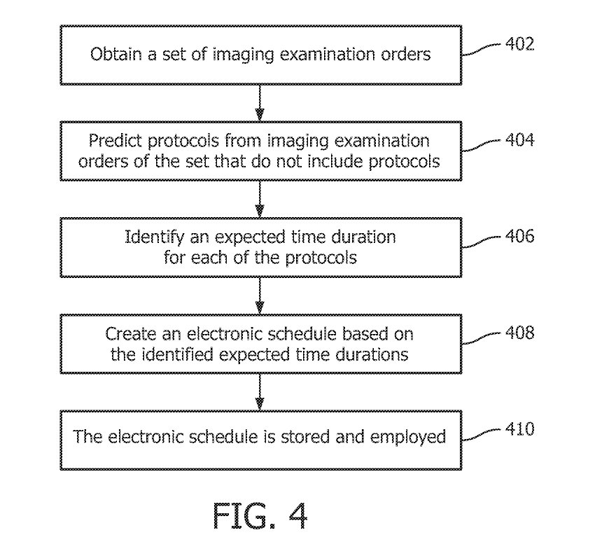

FIG. 4 illustrates another example method that facilitates generating a schedule for imaging examination orders.

FIG. 1 illustrates a system 100 with a computing apparatus 102 that includes at least one processor 104, which executes one or more computer readable instructions 106 stored in computer readable storage medium 108, such as physical memory or other non-transitory storage medium. The processor 104 can additionally or alternatively execute one or more computer readable instructions carried by a carrier wave, a signal or other transitory (or non-computer readable storage) medium.

The computing apparatus 102 receives information from one or more input devices 110 such as a keyboard, a mouse, a touch screen, etc. and/or conveys information to one or more output devices 112 such as one or more display monitors. The illustrated computing apparatus 102 is also in communication with a network 116 and one or more devices in communication with the network such as at least one client device 118, at least one data repository 120, at least one imaging system 124, and/or one or more other devices.

Examples of data repositories 120 include, but are not limited to, a picture archiving and communication system (PACS), a radiology information system (RIS), a hospital information system (HIS), and an electronic medical record (EMR). Examples of imaging systems 124 include, but are not limited to, a computed tomography (CT) system, a magnetic resonance (MR) system, a positron emission tomography (PET) system, a single photon emission computed tomography (SPECT) system, an ultrasound (US) system, and an X-ray imaging system.

The computing apparatus 102 can be a general purpose computer or the like located at a physician's office, a health care facility, an imaging center, etc. The computing apparatus 102 at least includes software that allows authorized personnel to generate electronic medical reports. The computing apparatus 102 can convey and/or receive information using formats such as Health Level Seven (HL7), Extensible Markup Language (XML), Digital Imaging and Communications in Medicine (DICOM), and/or one or more other format(s).

In the illustrated embodiment, the at least one computer readable instruction 106 includes imaging examination scheduling instructions (an imaging examination scheduler) 122, which when executed by the at least one processor 104 generates an electronic schedule of imaging examinations for subjects based on imaging examination orders, predicted and/or actual imaging protocols for the imaging examinations, and estimated time durations for the protocols.

As described in greater detail below, this is achieved based on prior knowledge of expected time durations of protocols assigned to imaging examinations, which is enabled by knowing, in advance, the imaging protocols for the imaging examinations, or at minimum, having a prediction of a likely protocol used in an imaging examination.

Furthermore, a distribution of the examination time duration for a protocol that is assigned (or predicted to be used) can be used. An optimization feature includes computing an ideal scheduled duration for each examination, the order, and the spacing between exams in order to meet operational constraints, such as worst-case or average-case durations.

Turning to FIG. 2, an example of the imaging examination scheduler 122 is schematically illustrated.

An information extractor 202 receives, as an input, imaging examination orders. An imaging examination order is for example entered via the at least one input device 110, the at least one client device 118, and/or otherwise.

The information extractor 202 extracts information from the order.

In the illustrated embodiment, the information extractor 202 first attempts to identify and extract an imaging protocol from each examination order. If an imaging protocol is identified and extracted, this information is provided to an expected examination duration identifier 206, which will be discussed in greater detail below.

The imaging protocol in the imaging examination order can be manually selected by a user, for example, through an electronic protocoling selection system or otherwise. Alternatively, the protocol is the “predicted protocol,” based on, for example, patent application Ser. No. 61/439,476, filed on Feb. 4, 2011, which is incorporated herein by reference. In this case, the protocol is one of multiple protocols, each with a probability.

If an imaging protocol is not identified from the order, the information extractor 202 extracts other information. For example, in the illustrated example, the information extractor 202 includes an imaging modality identifier 208 and an anatomy identifier 210, which, respectfully, extracts an imaging modality from the order and an anatomy of interest to be scanned from the order. For example, the extracted information includes “MRI” and “brain.” Another information identifier 212 may be configured to extract age, gender, ethnicity, medical history, etc. from an imaging examination order.

An imaging protocol predictor 214 predicts at least one protocol for an imaging examination order based on the extracted information from the imaging examination. In the illustrated embodiment, the imaging protocol predictor 214 selects at least one default protocol from a set of default protocols 216 stored in a protocol bank 218. In one instance, the default protocols are mapped to modalities and/or anatomy, and the imaging protocol predictor 214 predicts the protocol by selecting the at least one protocol corresponding to the extracted modality and/or anatomy (“MRI” and “brain” in the above example).

The selected at least one default (predicted) protocol is conveyed to the expected examination duration identifier 206. Other mappings that use additional information from the imaging examination order to further narrow the choice of predicted protocols are also contemplated, for example requests in the imaging examination order for the use of imaging contrast agents, patient disease state or other clinical history.

The expected examination duration identifier 206 identifies an expected examination time duration for each of the imaging protocols and the predicted imaging protocols. The expected examination duration identifier 206 can employ various approaches to identify an examination time duration.

By way of non-limiting example, in one instance, the expected examination duration identifier 206 identifies an expected time duration based on statistics such as a mean time (number of minutes) for the protocol, a median time for the protocol, an Nth percentile for the protocol (e.g., 75^{th} percentile time in which 75% of exams of this particular duration or less) where N is an integer from zero to one hundred, and/or other descriptors. Such descriptors may be determined by computing statistics from a database of previous examinations, the protocol, and the examination durations.

In another instance, these descriptors are provided in a look-up table, which may be populated through pre-calculation (e.g., based on statistics) and/or may be entered manually based on information from other sources (such as from workflow studies, literature reviews, policy, etc.) In another instance, these descriptors include a distribution (histogram) of the durations of previous examinations and/or a mathematical description of such a probability distribution.

In another instance, the expected examination time duration is based on further characteristics of the subject, including, but not limited to, age, medical condition, a ratio between actual previous scan time durations for the subject and an expected time duration for the protocol (e.g., accounting for a patient who is likely to be uncooperative based on their age, condition, or the fact that in previous scans they were uncooperative and thus the scans “ran long”).

A schedule creator 220 creates an electronic or an electronically formatted schedule based on the imaging protocol or the predicted imaging protocol and the expected exam time duration. In one instance, the schedule creator 220 obtains, as input, a set of expected examination durations for all of the examinations in a given time period and optimally places those imaging examinations into a schedule given a number of requirements and/or constraints.

The time period may be, e.g., a day, and the schedule creator 220 allocates all the examinations for a single day such that they “best” fit into the schedule. In a practical workflow, the time period may be several hours (e.g. morning, afternoon, or evening), such that the patient can be provided a broad time slot immediately after the order is received (e.g. “between noon and 5 pm on August 20”), and then be given a refined time slot two or three days before, when the protocol is known (“3:15-4:00 pm on August 20”).

The constraints may include minimizing the total scheduled time (sum of all exam slot durations in that day, noting that an exam slot will likely be longer than the average time for that type of exam protocol) while ensuring that the “worst case” (sum of all 95^{th} percentile scan durations or similar metric for the specified types) does not exceed some specified time metric. This may be formalized for mathematical optimization in the form of a cost or energy function, which is a mathematical combination of the various descriptors with penalties for time over-runs and the like.

In one instance, the schedule creator 220 employs an algorithm such as a genetic algorithm, simulated annealing, linear programming, or the like. In another instance, a cost function can be computed via Monte Carlo simulations, that is, by simulating a large number of patients and sampling for the exam duration distributions, and then computing a worst case, average case, percentile case, etc.

Optionally, when computing probabilities, the probability of each protocol can be employed for optimization. For example, an examination may be associated with a number of possible protocols, each with a probability (e.g. “a 82% chance that Protocol A will eventually be chosen for this patient, 10% for protocol B, and 8% for Protocol C”).

The electronic schedule is stored as a schedule 222 in schedule storage 224. The schedule 222 can be loaded into a RIS and/or other scheduling or calendar application.

In the event the schedule needs to be adjusted, for example, where an emergency examination pre-empts a scheduled examination, the expected examination time durations can be used to determine which examinations to post-pone, which to keep at their scheduled time, and/or which to move to another time. This can be performed to minimize the impact on the current schedule, ensure highest priority examinations are performed first, etc.

FIG. 3 illustrates an example flow chart in accordance with the disclosure herein.

It is to be appreciated that the ordering of the acts in the methods described herein is not limiting. As such, other orderings are contemplated herein. In addition, one or more acts may be omitted and/or one or more additional acts may be included.

At 302, a set of imaging examination orders is obtained. As discussed herein, the imaging examination orders in an electronic format.

At 304, for imaging examination orders of the set in which a protocol is included in the order, the protocols are extracted.

At 306, an expected examination time duration for each of the imaging examination orders of the set is identified.

The expected examination time duration can be identified as discussed herein and/or otherwise.

At 308, an electronic schedule is created for the set of imaging examination orders based at least on the expected examination time durations.

The electronic schedule can be created based on requirements and/or constraints as discussed herein and/or otherwise.

At 310, the electronic schedule is stored in memory and employed. This includes performing the imaging examination according to the schedule.

FIG. 4 illustrates an example flow chart in accordance with the disclosure herein.

It is to be appreciated that the ordering of the acts in the methods described herein is not limiting. As such, other orderings are contemplated herein. In addition, one or more acts may be omitted and/or one or more additional acts may be included.

At 402, a set of imaging examination orders is obtained. As discussed herein, the imaging examination orders in an electronic format.

At 404, for imaging examination orders of the set in which a protocol is not included in the order, protocols are predicted.

As discussed herein, a protocol can be predicted based on various information such as a modality, an anatomy of interest to be scanned, etc.

At 406, an expected examination time duration for each of the imaging examination orders of the set is identified.

The expected examination time duration can be identified as discussed herein and/or otherwise.

At 408, an electronic schedule is created for the set of imaging examination orders based at least on the expected examination time durations.

The electronic schedule can be created based on requirements and/or constraints as discussed herein and/or otherwise.

At 410, the electronic schedule is stored in memory and employed. This includes performing the imaging examination according to the schedule.

A variation includes a combination of FIGS. 3 and 4 and/or at least one of FIG. 3 or 4 and other acts.

The above may be implemented by way of computer readable instructions, encoded or embedded on computer readable storage medium, which, when executed by a computer processor(s), cause the processor(s) to carry out the described acts. Additionally or alternatively, at least one of the computer readable instructions is carried by a signal, carrier wave or other transitory medium.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof

1. A method for creating an electronically formatted schedule for imaging examinations, comprising:
receiving a set of imaging examination orders;
determining a protocol for each imaging examination order in the set of imaging examination orders;
identifying an expected examination time duration of each of the protocols; and
creating the electronically formatted schedule based on the expected examination time durations.

2. The method of claim 1, further comprising:
extracting at least one of the determined protocols from a corresponding imaging examination order.

3. The method of any of claims 1 to 2, further comprising:
predicting at least one of the determined protocols for an imaging examination order that does not include a protocol.

4. The method of claim 3, wherein the protocol is predicted based on at least one of an imaging modality, an anatomy of interest, a request for a contrast agent, or a patient history extracted from the imaging examination order.

5. The method of any of claims 1 to 4, further comprising:
identifying an expected examination time duration for an order based on statistics.

6. The method of claim 5, wherein the expected examination time duration is at least one of a mean time duration for the protocol from previously performed examinations, a median time duration for the protocol from previously performed examinations, or an Nth percentile time duration for the protocol from previously performed examinations, where N percent of the previously performed examinations had a time duration of the expected examination time duration or less.

7. The method of any of claims 1 to 4, further comprising:
identifying an expected examination time duration for an order based on a look-up table.

8. The method of claim 7, wherein the look-up table is at least one of populated based on statistics or manually populated.

9. The method of any of claims 1 to 4, further comprising:
identifying an expected examination time duration for an order based on at least one of a distribution of the time durations of the previous examinations or a mathematical description of a probability distribution of the time durations.

10. The method of any of claims 1 to 9, further comprising:
identifying an expected examination time duration for an order based on a characteristic of a subject corresponding to an order, wherein the characteristic includes at least one of an age, a medical condition, a ratio between actual previous scan time durations for the subject and expected time durations for the protocols.

11. The method of any of claims 1 to 10, further comprising:
receiving a set of expected examination durations for all of the examinations in a given time period; and
assigning all the examinations of the set for a single time period to best fit the schedule.

12. The method of claim 11, further comprising:
updating an initial broad time slot provided to a subject before the creation of the electronic schedule with a refined time slot from the created electronic schedule.

13. The method of any of claims 11 to 12, further comprising:
assigning all the examinations to minimize a total scheduled time while ensuring that a worst case does not exceed a predetermined time duration.

14. The method of claim 13, wherein the total scheduled time is a sum of all exam slot durations in a day, where an exam time slot is longer than an average time for the examination protocol, and the worst case is a sum of all scan durations for a predetermined time duration.

15. A computing apparatus (102), comprising:
an input device (110) that receives a set of imaging examination orders;
an information extractor (202) that extracts information that identifies a protocol of each imaging examination orders in the set;
an expected examination duration identifier (206) that identifies an expected examination time duration of each of the protocols; and
a schedule creator (220) that creates an electronically formatted schedule for the set of imaging examination orders based on the expected examination time durations.

16. The computing apparatus of claim 15, wherein the information extractor extracts at least one of the determined protocols from a corresponding imaging examination order.

17. The computing apparatus of any of claims 15 to 16, further comprising:
an imaging protocol predictor (214) that predicts at least one of the determined protocols for an imaging examination order that does not include a protocol.

18. The computing apparatus of claim 17, wherein the protocol is predicted based on at least one of an imaging modality, an anatomy of interest, a request for a contrast agent, or a patient history extracted from the imaging examination order.

19. The computing apparatus of any of claims 15 to 18, wherein the expected examination time duration for an order is determined based on statistics.

20. The computing apparatus of any of claims 15 to 19, wherein the expected examination time duration for an order is determined based on a look-up table.

21. The computing apparatus of any of claims 15 to 19, wherein the expected examination time duration for an order is determined based on at least one of a distribution of the time durations of the previous examinations or a mathematical description of a probability distribution of the time durations.

22. The computing apparatus of any of claims 15 to 21, wherein the expected examination time duration for an order is determined based at least one of an age, a medical condition, a ratio between actual previous scan time durations for the subject and expected time durations for the protocols.

23. The computing apparatus of any of claims 15 to 22, wherein the schedule creator assigns the examinations within a given time period to time slots that best fit the schedule.

24. The computing apparatus of any of claims 15 to 23, wherein the schedule creator assigns the examinations to minimize a total scheduled time while ensuring that a worst case does not exceed a predetermined time metric.

25. The computing apparatus of claim 24, wherein the total scheduled time is a sum of all exam slot durations in a day, where an exam time slot is longer than an average time for the examination protocol and the worst case is a sum of all scan durations for a predetermined time duration.

26. A computer readable storage medium encoded with computer readable instructions, which, when executed by a processer, causes the processor to:
receive a set of imaging examination orders;
determine a protocol of each of the imaging examination orders in the set of imaging examination orders;
identify an expected examination time duration of each of the protocols; and
create the electronically formatted schedule based on the expected examination time durations.
